(19) United States
(12) Patent Application Publication
(10) Pub. No.: US 2006/0097480 A1
(43) Pub. Date: May 11, 2006

(54) Trailer hitch guide and step

(76) Inventor: Raymond L. Hegefeld, Forney, TX (US)

Correspondence Address: W. THOMAS TIMMONS;THE WHITE HOUSE ON TURTLE CREEK, 2401 TURTLE CREEK BLVD, DALLAS, TX, 75219-4760, US

(21) Appl. No.: 11/225,455

(22) Filed: Sep. 13, 2005

Related U.S. Application Data
(60) Provisional application No. 60/609,798, filed on Sep. 14, 2004.

(51) Int. Cl. B60D 1/36

(52) U.S. Cl. 280/477

(57) ABSTRACT

A trailer hitch guide and step is disclosed, which includes the combination of a drawbar, a ball mount affixed to the drawbar, an alignment guide centered between the ball mount and the drawbar and a brace affixed to the drawbar and affixed to the back of the alignment guide. The alignment guide includes a back, two sides extending at angles of from about 40 degrees to about 50 degrees, and preferably approximately 45 degrees, from the edges of the back and two wings extending in curving arcs out from the edges of the two sides opposite the edges attached to the back. In a preferred arrangement, the two side are of equal length and the width of the back is greater than half the length of either side and the length of the two wings are equal and greater than half the length of the two sides. The brace is in the shape of a right triangle with one leg affixed to the drawbar and one leg affixed to the back of the alignment guide. The thickness of the alignment guide and the thickness of the brace are sufficient to support the weight of an adult, typically at least one fourth inch. In a preferred arrangement, the wings form angles of from about 25 degrees to about 35 degrees with respect to the sides, and preferably at angles of approximately 30 degrees.

### CROSS-REFERENCE TO RELATED APPLICATIONS

### STATEMENT REGARDING FEDERALLY SPONSORED RESEARCH OR DEVELOPMENT.

Not Applicable

### INCORPORATION-BY-REFERENCE OF MATERIAL SUBMITTED ON A COMPACT DISC.

Not Applicable

### BACKGROUND OF THE INVENTION

1. Field of the Invention

This invention relates generally to trailer hitches and in particular to guides for aligning towed vehicles to towing vehicles.

2. Description of Related Art

Guides for aligning trailer hitch ball sockets with hitch balls on towing vehicles are well know. Many are designed for step style bumpers. Others are designed to be removable so that they will not be damaged or limit turning ability.

### BRIEF SUMMARY OF THE INVENTION

A trailer hitch guide and step according to the present invention includes the combination of a drawbar, a ball mount affixed to the drawbar, an alignment guide centered between the ball mount and the drawbar and a brace affixed to the drawbar and affixed to the back of the alignment guide. The alignment guide includes a back, two sides extending at angles of from about 40 degrees to about 50 degrees, and preferably approximately 45 degrees, from the edges of the back and two wings extending in curving arcs out from the edges of the two sides opposite the edges attached to the back. In a preferred arrangement, the two side are of equal length and the width of the back is greater than half the length of either side and the length of the two wings are equal and greater than half the length of the two sides. The brace is in the shape of a right triangle with one leg affixed to the drawbar and one leg affixed to the back of the aligmnent guide. The thickness of the alignment guide and the thickness of the brace are sufficient to support the weight of an adult, typically at least one fourth inch. In a preferred arrangement, the wings form angles of from about 25 degrees to about 35 degrees with respect to the sides, and preferably at angles of approximately 30 degrees.

These and other objects, advantages and features of this invention will be apparent from the following description taken with reference to the accompanying drawing, wherein is shown a preferred embodiment of the invention.

### BRIEF DESCRIPTION OF THE SEVERAL VIEWS OF THE DRAWING

FIG. 1 is a top right perspective view of an alignment guide according to the present invention;

FIG. 2 is a right front perspective view of a brace according to the present invention;

FIG. 3 is a top right perspective view of a trailer hitch guide and step according to the present invention;

FIG. 4 is a top right perspective view of an alternative embodiment of a trailer hitch guide and step according to the present invention; and

FIG. 5 is a front elevation view of the trailer hitch guide and step of FIG. 4.

### DETAILED DESCRIPTION OF THE INVENTION

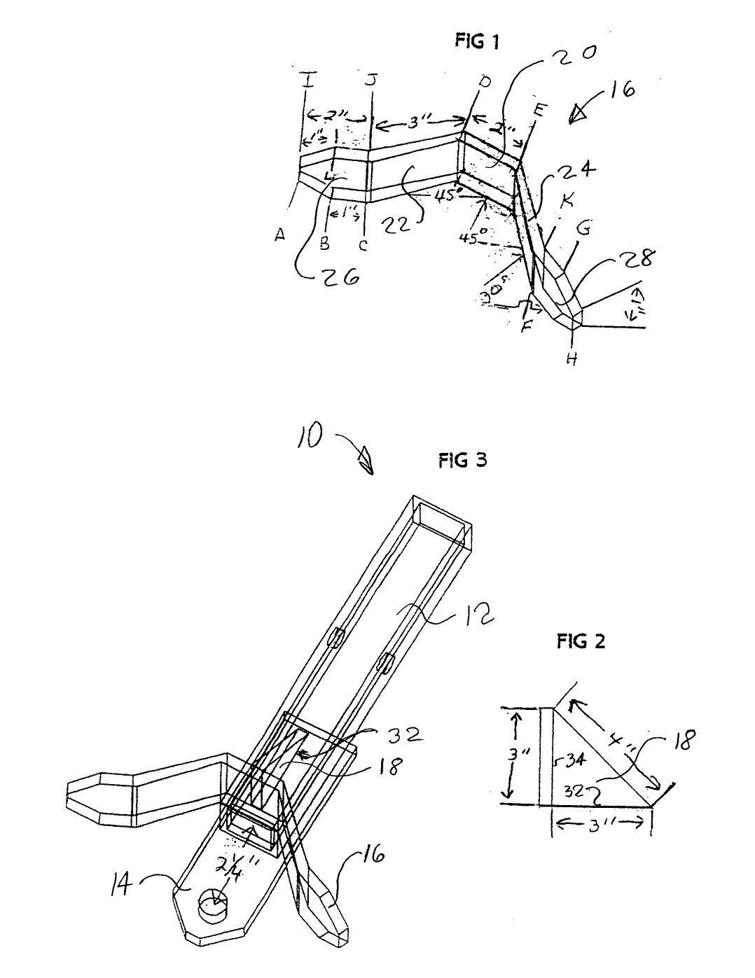

Referring now to the drawing, and in particular to FIGS. 1 through 3, a trailer hitch guide and step according to the present invention is referred to generally by reference numeral 10. Trailer hitch guide and step 10 includes the combination of a drawbar 12, a ball mount 14 affixed to the drawbar, an alignment guide 16 centered between the ball mount and the drawbar and a brace 18 affixed to the drawbar and affixed to the back of the alignment guide. The alignment guide includes a back 20, two sides 22 and 24 extending at angles 45 of from about 40 degrees to about 50 degrees, and preferably approximately 45 degrees, from the edges of the back and two wings 26 and 28 extending in curving arcs out from the edges of the two sides opposite the edges attached to the back. In a preferred arrangement, the two side are of equal length and the width of the back is greater than half the length of either side and the length of the two wings are equal and greater than half the length of the two sides. Brace 18 is basically in the shape of a right triangle with one leg 32 affixed to drawbar 12 and one leg 34 affixed to the back of the alignment guide. The thickness of the alignment guide and the thickness of the brace are sufficient to support the weight of an adult, typically at least one fourth inch. In a preferred arrangement, the wings form angles 30 of from about 25 degrees to about 35 degrees with respect to the sides, and preferably at angles of approximately 30 degrees.

Referring specially to FIG. 1, typically, a flat 12 inch by 3 inch by ⅜ inch metal is cut from each end and side at an approximately 45 degrees points A to B and I to L and repeat at the other end. These cuts form a safer, neater, rounded appearance at both ends of the alignment guide. Then it is bent at approximately 45 degrees 5 inches from each end at points D and E. Then it is bent at approximately 30 degrees 2 inches from both ends in the opposite directions at points J and C and F and K. Referring also to FIG. 3, alignment guide 16 and brace 18 are welded on a ball mount with 2¼ inch center of the alignment guide.

Preferably, alignment guide 16 is not more than 1 inch below the top of the ball so the alignment guide can guide a trailer coupler to the proper location. Lower jack and ball will enter the coupler with minimum pushing and pulling.

The 3 inch by 3 inch by 4 inch by ⅜ inch triangle brace 18 fits in the middle of the 2 inches with edge. Alignment guide 16 and brace 18 are welded to the ball mount on both sides. This adds strength to the alignment guide. The self aligning alignment guide can be mounted on most existing ball mounts. The back brace can be modified for each style of ball mount. It also becomes clear that although the parts of alignment guide are discussed separately, they can be affixed to each other by being part of an integral whole.

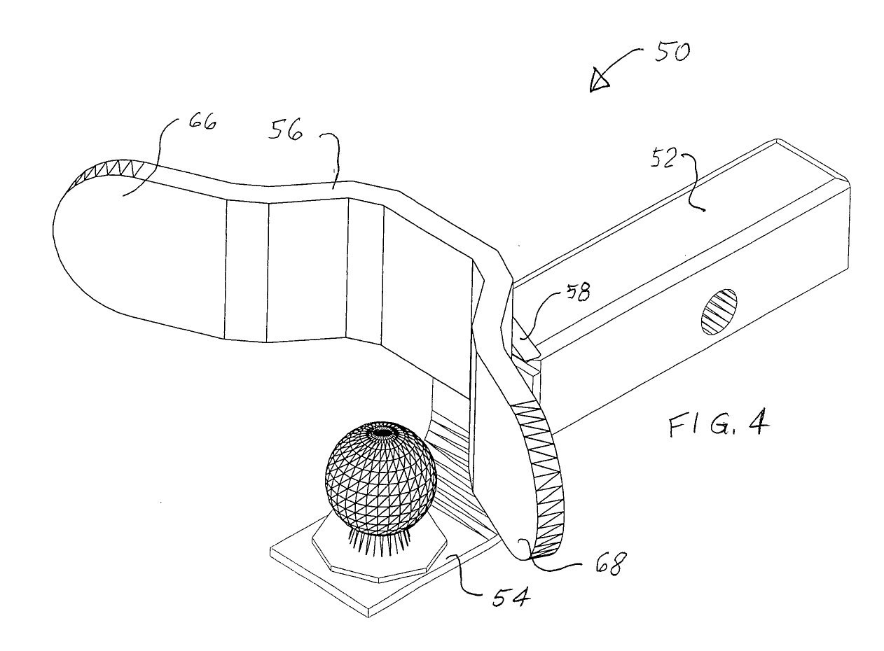

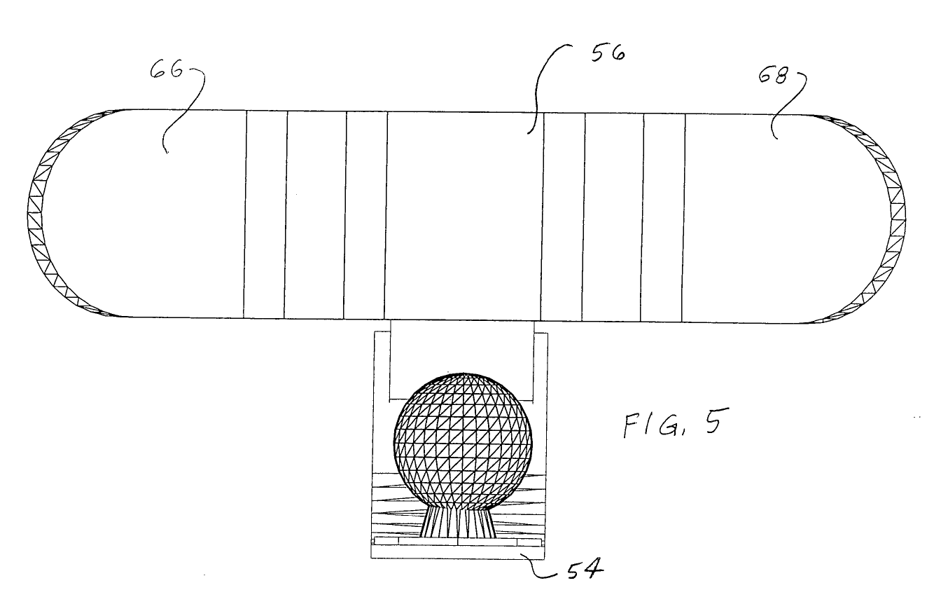

Referring now to FIG. 4 and FIG. 5, an alternative embodiment of a trailer hitch guide and step according to the present invention is referred to generally by reference numeral 50. Trailer hitch guide and step 50 includes the combination of a drawbar 52, a ball mount 54 affixed to the drawbar, an alignment guide 56 centered between the ball mount and the drawbar and a brace 58 affixed to the drawbar and affixed to the back of the alignment guide. Wings 66 and 68 are rounded and brace 58 is shaped like a truncated right triangle in cross section.

It is now easy to see that the trailer hitch guide of the present invention is designed to stay in place and is strong enough to also serve as a step which is convenient for accessing the truck bed or when securing the ball socket of the trailer onto the hitch ball. Further, the angles of the alignment guide allow the trailer to be at an almost 90 degree angle with respect to the towing vehicle.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

1. A trailer hitch guide and step comprising in combination:
a drawbar;
a ball mount affixed to the drawbar;
an alignment guide centered between the ball mount and the drawbar; and
a brace affixed to the drawbar and affixed to the back of the alignment guide;

2. A trailer hitch guide and step according to claim 1, wherein the alignment guide comprises a back, two sides extending at angles of from about 40 degrees to about 50 degrees from the edges of the back and two wings extending in curving arcs out from the edges of the two sides opposite the edges attached to the back.

3. A trailer hitch guide and step according to claim 2, wherein the two side are of equal length and the width of the back is greater than half the length of either side and the length of the two wings are equal and greater than half the length of the two sides.

4. A trailer hitch guide and step according to claim 3, wherein the brace is in the shape of a right triangle or a truncated right triangle with one leg affixed to the drawbar and one leg affixed to the back of the alignment guide.

5. A trailer hitch guide and step according to claim 4, wherein the thickness of the alignment guide and the thickness of the brace are at least one fourth inch.

6. A trailer hitch guide and step according to claim 2, wherein the wings form angles of from about 25 degrees to about 35 degrees with respect to the sides.

7. A trailer hitch guide and step according to claim 6, wherein the two side are of equal length and the width of the back is greater than half the length of either side and the length of the two wings are equal and greater than half the length of the two sides.

8. A trailer hitch guide and step according to claim 7, wherein the brace is in the shape of a right triangle or a truncated right triangle with one leg affixed to the drawbar and one leg affixed to the back of the alignment guide.

9. A trailer hitch guide and step according to claim 8, wherein the thickness of the alignment guide and the thickness of the brace are at least one fourth inch.

10. A trailer hitch guide and step according to claim 1, wherein the alignment guide comprises a back, two sides extending at angles of approximately 45 degrees from the edges of the back and two wings extending in curving arcs out from the edges of the two sides opposite the edges attached to the back.

11. A trailer hitch guide and step according to claim 10, wherein the two side are of equal length and the width of the back is greater than half the length of either side and the length of the two wings are equal and greater than half the length of the two sides.

12. A trailer hitch guide and step according to claim 11, wherein the brace is in the shape of a right triangle or a truncated right triangle with one leg affixed to the drawbar and one leg affixed to the back of the alignment guide.

13. A trailer hitch guide and step according to claim 12, wherein the thickness of the alignment guide and the thickness of the brace are at least one fourth inch.

14. A trailer hitch guide and step according to claim 10, wherein the wings form angles of approximately 30 degrees with respect to the sides.

15. A trailer hitch guide and step according to claim 14, wherein the two side are of equal length and the width of the back is greater than half the length of either side and the length of the two wings are equal and greater than half the length of the two sides.

16. A trailer hitch guide and step according to claim 15, wherein the brace is in the shape of a right triangle or a truncated right triangle with one leg affixed to the drawbar and one leg affixed to the back of the alignment guide.

17. A trailer hitch guide and step according to claim 16, wherein the thickness of the alignment guide and the thickness of the brace are at least one fourth inch.
